(19) United States
(12) Patent Application Publication
(10) Pub. No.: US 2022/0178266 A1
(43) Pub. Date: Jun. 9, 2022

(54) FAST RESPONSE ACTIVE CLEARANCE CONTROL SYSTEM WITH PIEZOELECTRIC ACTUATOR

(71) Applicant: General Electric Company, Schenectady, NY (US)

(72) Inventor: Taehong Kim, West Chester, OH (US)

(21) Appl. No.: 17/112,320

(22) Filed: Dec. 4, 2020

(51) Int. Cl. F01D 11/22

(52) U.S. Cl. CPC F01D 11/22; F05D 2260/407; F05D 2270/303; F05D 2220/323; F05D 2270/301; F05D 2240/11

(57) ABSTRACT

Certain examples disclose and describe apparatus and methods to provide fast response active clearance control system with piezoelectric actuator. In some examples, an apparatus includes a case surrounding at least part of a turbine engine, the at least part of the turbine engine including at least one of a shroud or a hanger to contain airflow in the at least part of the turbine engine. The apparatus further includes an actuator to control clearance between a blade and the at least one of the shroud or the hanger, the actuator including a multilayer stack of material, and wherein the actuator is outside of the case. The apparatus further includes a rod coupled to the actuator and the at least one of the shroud or the hanger through an opening in the case, the rod to move the at least one of the shroud or the hanger based on the actuator.

### FIELD OF THE DISCLOSURE

This disclosure relates generally to a gas turbine engine, and, more particularly, to fast response active clearance control system with piezoelectric actuator.

### BACKGROUND

A gas turbine engine generally includes, in serial flow order, an inlet section, a compressor section, a combustion section, a turbine section, and an exhaust section. In operation, air enters the inlet section and flows to the compressor section where one or more axial compressors progressively compress the air until it reaches the combustion section. Fuel mixes with the compressed air and burns within the combustion section, thereby creating combustion gases. The combustion gases flow from the combustion section through a hot gas path defined within the turbine section and then exit the turbine section via the exhaust section.

In general, it is desirable for a gas turbine engine to maintain clearance between the tip of a blade in the gas turbine engine and the stationary parts of the gas turbine engine (e.g., the gas turbine engine casing, stator, etc.). During operation, the gas turbine engine is exposed to thermal (e.g., hot and cold air pumped into the gas turbine engine, etc.) and mechanical loads (e.g., centrifugal force on the blades on the gas turbine engine, etc.), which can expand and contract the gas turbine engine casing and rotor. The expansion and contraction of the gas turbine engine casing can change the clearance between the blade tip and the stationary parts of the gas turbine engine. There is a continuing need to control the clearance between the blade tip and the engine casing that fluctuates during normal operation for a gas turbine engine to avoid damage to the gas turbine engine (e.g., wear, breakage, etc. due to unintentional rub).

### BRIEF DESCRIPTION OF THE DRAWINGS

FIG. 1 is a schematic cross-sectional view of an example gas turbine engine in accordance with the examples disclosed herein.

FIG. 2 is a schematic cross-sectional view of an example gas turbine engine with a conventional active clearance control (ACC) system.

FIG. 3 is a schematic cross-sectional view of a prior ACC system for a gas turbine engine.

FIGS. 4A and 4B are schematic cross-sectional views of a first example ACC system in accordance with teachings disclosed herein.

FIGS. 5A and 5B are schematic cross-sectional views of a second example ACC system in accordance with teachings disclosed herein.

FIGS. 6A and 6B are schematic cross-sectional views of a third example ACC system in accordance with teachings disclosed herein.

FIG. 7 is a block diagram of an example controller of the example ACC systems of FIGS. 4A, 4B, 5A, 5B, 6A, and 6B.

FIG. 8 is a flowchart representative of machine readable instructions which may be executed to implement the example controller of FIG. 7 in conjunction with the example ACC system of FIGS. 4A, 4B.

FIG. 9 is a flowchart representative of machine readable instructions which may be executed to implement the example controller of FIG. 7 in conjunction with the example ACC system of FIGS. 5A, 5B.

FIG. 10 is a flowchart representative of machine readable instructions which may be executed to implement the example controller of FIG. 7 in conjunction with the example ACC system of FIGS. 6A, 6B.

FIG. 11 is a block diagram of an example processing platform structured to execute the instructions of FIGS. 8, 9, 10 to implement the example controller of FIG. 7.

The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular. In general, the same reference numbers will be used throughout the drawing(s) and accompanying written description to refer to the same or like parts. As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections.

### BRIEF SUMMARY

Methods, apparatus, systems, and articles of manufacture to provide fast response active clearance control with piezoelectric actuator are disclosed.

Certain examples provide an apparatus including a case surrounding the at least part of the turbine engine, the at least part of the turbine engine including at least one of a shroud or a hanger to contain airflow in the at least part of the turbine engine, an actuator to control clearance between a blade and the at least one of the shroud or the hanger, the actuator including a multilayer stack of material, and wherein the actuator is outside of the case, and a rod coupled to the actuator and the at least one of the shroud or the hanger through an opening in the case, the rod to move the at least one of the shroud or the hanger based on the actuator.

Certain examples provide an apparatus including a case surrounding at least part of the turbine engine, the at least part of the turbine engine including at least one of a shroud or a hanger to contain airflow in the at least part of the turbine engine, a first actuator to control clearance between a blade and the at least one of the shroud or the hanger, the first actuator including a first multilayer stack of material, and wherein the first actuator is coupled to the at least one of the shroud or a first hook of the hanger, and a second actuator to control clearance between the blade and the at least one of the shroud or the hanger, the second actuator including a second multilayer stack of material, and wherein the second actuator is coupled to the at least one of the shroud or a second hook of the hanger.

Certain examples provide a non-transitory computer readable medium comprising instructions that, when executed, cause at least one processor to at least monitor condition parameters from sensor devices in a turbine engine, determine when turbine engine conditions indicate if a case is expanding or shrinking, wherein the turbine engine conditions are based on the condition parameters, the case surrounding at least part of the turbine engine, in response to determining that the turbine engine conditions indicate the case is expanding, transmit a first electrical current to a multilayer stack of material, and in response to determining that the turbine engine conditions indicate the case is shrinking, transmit a second electrical current to the multilayer stack of material.

### DETAILED DESCRIPTION

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized. The following detailed description is therefore, provided to describe example implementations and not to be taken limiting on the scope of the subject matter described in this disclosure. Certain features from different aspects of the following description may be combined to form yet new aspects of the subject matter discussed below.

When introducing elements of various embodiments of the present disclosure, the articles “a,” “an,” “the,” and “said” are intended to mean that there are one or more of the elements. The terms “first,” “second,” and the like, do not denote any order, quantity, or importance, but rather are used to distinguish one element from another. The terms “comprising,” “including,” and “having” are intended to be inclusive and mean that there may be additional elements other than the listed elements. As the terms “connected to,” “coupled to,” etc. are used herein, one object (e.g., a material, element, structure, member, etc.) can be connected to or coupled to another object regardless of whether the one object is directly connected or coupled to the other object or whether there are one or more intervening objects between the one object and the other object.

As used herein, the terms “system,” “unit,” “module,” “engine,” etc., may include a hardware and/or software system that operates to perform one or more functions. For example, a module, unit, or system may include a computer processor, controller, and/or other logic-based device that performs operations based on instructions stored on a tangible and non-transitory computer readable storage medium, such as a computer memory. Alternatively, a module, unit, engine, or system may include a hard-wired device that performs operations based on hard-wired logic of the device. Various modules, units, engines, and/or systems shown in the attached figures may represent the hardware that operates based on software or hardwired instructions, the software that directs hardware to perform the operations, or a combination thereof.

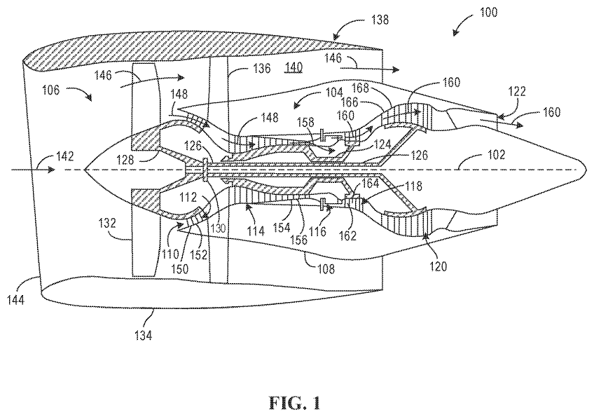

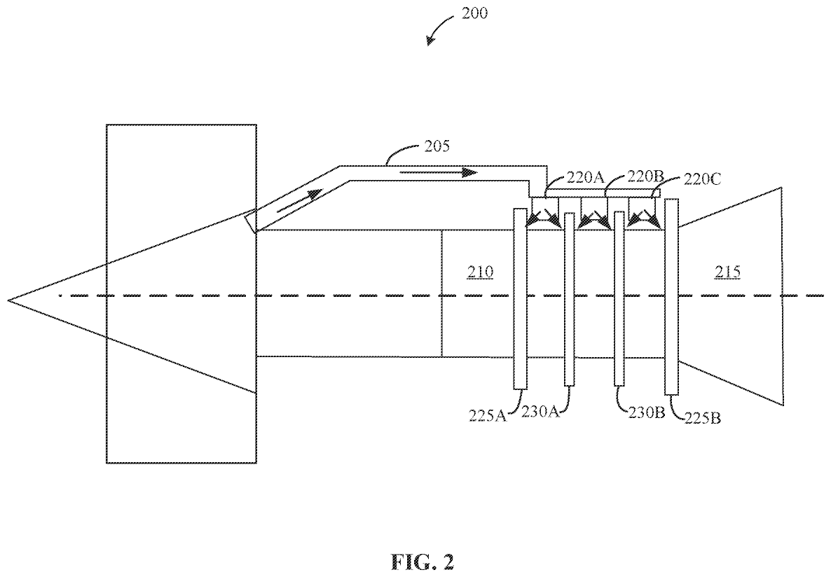

The terms “upstream” and “downstream” refer to the relative direction with respect to fluid flow in a fluid pathway. For example, “upstream” refers to the direction from which the fluid flows, and “downstream” refers to the direction to which the fluid flows. As used herein, “vertical” refers to the direction perpendicular to the ground. As used herein, “horizontal” refers to the direction parallel to the centerline of the gas turbine engine 100. As used herein, “lateral” refers to the direction perpendicular to the axial and vertical directions (e.g., into and out of the plane of FIGS. 1, 2, etc.).

In some examples used herein, the term “substantially” is used to describe a relationship between two parts that is within three degrees of the stated relationship (e.g., a substantially colinear relationship is within three degrees of being linear, a substantially perpendicular relationship is within three degrees of being perpendicular, a substantially parallel relationship is within three degrees of being parallel, etc.).

A turbine engine, also called a combustion turbine or a gas turbine, is a type of internal combustion engine. Turbine engines are commonly utilized in aircraft and power-generation applications. As used herein, the terms “asset,” “aircraft turbine engine,” “gas turbine,” “land-based turbine engine,” and “turbine engine” are used interchangeably. A basic operation of the turbine engine includes an intake of fresh atmospheric air flow through the front of the turbine engine with a fan. In some examples, the air flow travels through an intermediate-pressure compressor or a booster compressor located between the fan and a high-pressure compressor. A turbine engine also includes a turbine with an intricate array of alternating rotating and stationary airfoil-section blades. As the hot combustion gas passes through the turbine, the hot combustion gas expands, causing the rotating blades to spin.

The components of the turbine engine (e.g., the fan, the booster compressor, the high-pressure compressor, the high-pressure turbine, the low-pressure turbine, etc.) can degrade over time due to demanding operating conditions such as extreme temperature and vibration. During operation, the turbine engine components are exposed to thermal (e.g., hot and cold air pumped into the turbine engine, etc.) and mechanical loads (e.g., centrifugal force on the blades on the turbine engine, etc.), which can expand and contract the turbine engine casing and/or compressor casing within the turbine engine along with other components of the turbine engine and/or its compressor. The expansion and contraction of the turbine engine casing and/or compressor casing within the turbine engine can change the clearance between the blades' tips and the stationary components of the turbine engine. In some examples, if the clearance between the blades' tips and the stationary components is not controlled, then the blades' tips and stationary components can collide during operation and lead to further degradation of the components of the turbine engine.

The Active Clearance Control (ACC) System was developed to optimize blade tip clearance for engine performance improvement without unexpected harmful rub events during flight and ground operations. A conventional ACC System includes using cooling air from a fan or compressor to control the clearance between the blade tip and an engine component that has shrunk (e.g., the stator, the case, etc.). The conventional ACC system is limited in that clearance is only modulated in one direction (e.g., engine component shrinkage). For a hot rotor condition (e.g., the engine component(s) are expanded), the conventional ACC system must wait for rotor-stator thermal/mechanical growth matching to escape the hot rotor condition (e.g., modulate the blade tip clearance).

Examples disclosed herein optimize and/or otherwise improve an ACC system using piezoelectric actuator(s) that provide fast response clearance control without the mechanical delay seen in the conventional ACC system. Examples disclosed herein maintain desired clearances between the blade tip and other engine components without additional margin for various operating conditions, which will lead to performance improvement and provide better exhaust gas temperature (EGT) control capability. In certain examples, piezoelectric material generates linear displacement when an electric field is applied. The linear displacement can have a force, and examples disclosed herein apply the linear force of the piezoelectric material for the ACC system to achieve fast response clearance control. Examples disclosed herein apply the mechanical force from the linear displacement of the piezoelectric material on to modulating the ACC system. Examples disclosed herein can include other materials that generate linear displacement such as, shape memory alloy (SMA), etc. The range of displacement is increased by adding layers of piezoelectric material or SMA, called multilayer stacks, where more layers in a stack provides more radial movement range and gives the ACC system more muscle capability.

Examples disclosed herein use an actuator to house the piezoelectric material. The actuator achieves clearance in two directions (e.g., inward and outward). Examples disclosed herein do not need additional clearance margin for maximum transient closure or hot-rotor condition like the conventional ACC system. Examples disclosed herein provide significant specific fuel consumption (SFC) improvement on tighter clearance and a better EGT control as there are no additional margins for transient closure or the hot rotor condition.

In the examples disclosed herein, the actuator for the piezoelectric material can provide a variety of design spaces with compact and simple piezo-stacks while providing the same high mechanical force as conventional ACC. Example disclosed herein propose three different mechanical design configurations for how to stack & locate piezoelectric material: (1) outside of a high pressure turbine (HPT) case or a compressor case (2) inside of hanger hooks and (3) inside of hanger hooks with springs. The example first mechanical design configuration includes an outer-stack piezoelectric actuator that generates a linear displacement from an applied electric field. The first mechanical design configuration has the benefit for easy access for maintenance and part replacement since the piezoelectric actuator is located outside the case (e.g., the HPT case, the compressor case, etc.), however, it also includes sealing concerns for the case. As the piezoelectric stack is located outside of the case, the first mechanical design configuration preserves the piezoelectric material in a cold condition, which reduces concern of temperature limitations for the piezoelectric material.

The example second mechanical design configuration includes an inner-stack piezoelectric actuator applies two actuators on hanger hooks under the case. The piezoelectric stacks are positioned on upper and lower surfaces of the hanger hooks to achieve more accurate modulation, and the second mechanical design configuration relatively reduces the concern for sealing resent in the first mechanical design configuration. However, this second mechanical design configuration does not allow easy access for maintenance or part replacement compared to the first mechanical design configuration. The third mechanical design configuration include two actuators on hanger hooks under the case. The actuators include inner-stacks of piezoelectric materials on an upper surface of the hanger hooks and springs on the lower surface of the hanger hooks. The third mechanical design configuration is a similar design to the second mechanical design configuration except including springs. The third mechanical design configuration needs less piezoelectric material stacks for cost, but it may cause uncertainty of modulation accuracy. The third mechanical design configuration also has the disadvantage for maintenance or part replacement compared to the first mechanical design configuration.

Certain examples provide an engine controller, referred to as a full authority digital engine (or electronics) control (FADEC). The FADEC includes a digital computer, referred to as an electronic engine controller (EEC) or engine control unit (ECU), and related accessories that control aspects of aircraft engine performance. The FADEC can be used with a variety of engines such as piston engines, jet engines, other aircraft engines, etc. In certain examples, the EEC/ECU is provided separate from the FADEC, allowing manual override or intervention by a pilot and/or other operator.

In examples disclosed herein, the engine controller receives values for a plurality of input variables relating to flight condition (e.g., air density, throttle lever position, engine temperatures, engine pressures, etc.). The engine controller computes engine operating parameters such as fuel flow, stator vane position, air bleed valve position, etc., using the flight condition data. The engine operating parameters can be used by the engine controller to control operation of the piezoelectric actuator(s) to modulate blade tip clearance in the turbine engine.

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

FIG. 1 is a schematic cross-sectional view of a conventional turbofan-type gas turbine engine 100 (“turbofan 100”). As shown in FIG. 1, the turbofan 100 defines a longitudinal or axial centerline axis 102 extending therethrough for reference. In general, the turbofan 100 may include a core turbine or gas turbine engine 104 disposed downstream from a fan section 106.

The core turbine 104 generally includes a substantially tubular outer casing 108 that defines an annular inlet 110. The outer casing 108 can be formed from a single casing or multiple casings. The outer casing 108 encloses, in serial flow relationship, a compressor section having a booster or low pressure compressor 112 (“LP compressor 112”) and a high pressure compressor 114 (“HP compressor 114”), a combustion section 116, a turbine section having a high pressure turbine 118 (“HP turbine 118”) and a low pressure turbine 120 (“LP turbine 120”), and an exhaust section 122. A high pressure shaft or spool 124 (“HP shaft 124”) drivingly couples the HP turbine 118 and the HP compressor 114. A low pressure shaft or spool 126 (“LP shaft 126”) drivingly couples the LP turbine 120 and the LP compressor 112. The LP shaft 126 may also couple to a fan spool or shaft 128 of the fan section 106. In some examples, the LP shaft 126 may couple directly to the fan shaft 128 (i.e., a direct-drive configuration). In alternative configurations, the LP shaft 126 may couple to the fan shaft 128 via a reduction gear 130 (i.e., an indirect-drive or geared-drive configuration).

As shown in FIG. 1, the fan section 106 includes a plurality of fan blades 132 coupled to and extending radially outwardly from the fan shaft 128. An annular fan casing or nacelle 134 circumferentially encloses the fan section 106 and/or at least a portion of the core turbine 104. The nacelle 134 is supported relative to the core turbine 104 by a plurality of circumferentially-spaced apart outlet guide vanes 136. Furthermore, a downstream section 138 of the nacelle 134 can enclose an outer portion of the core turbine 104 to define a bypass airflow passage 140 therebetween.

As illustrated in FIG. 1, air 142 enters an inlet portion 144 of the turbofan 100 during operation thereof. A first portion 146 of the air 142 flows into the bypass flow passage 140, while a second portion 148 of the air 142 flows into the inlet 110 of the LP compressor 112. One or more sequential stages of LP compressor stator vanes 150 and LP compressor rotor blades 152 coupled to the LP shaft 126 progressively compress the second portion 148 of the air 142 flowing through the LP compressor 112 en route to the HP compressor 114. Next, one or more sequential stages of HP compressor stator vanes 154 and HP compressor rotor blades 156 coupled to the HP shaft 124 further compress the second portion 148 of the air 142 flowing through the HP compressor 114. This provides compressed air 158 to the combustion section 116 where it mixes with fuel and burns to provide combustion gases 160.

The combustion gases 160 flow through the HP turbine 118 in which one or more sequential stages of HP turbine stator vanes 162 and HP turbine rotor blades 164 coupled to the HP shaft 124 extract a first portion of kinetic and/or thermal energy from the combustion gases 160. This energy extraction supports operation of the HP compressor 114. The combustion gases 160 then flow through the LP turbine 120 where one or more sequential stages of LP turbine stator vanes 166 and LP turbine rotor blades 168 coupled to the LP shaft 126 extract a second portion of thermal and/or kinetic energy therefrom. This energy extraction causes the LP shaft 126 to rotate, thereby supporting operation of the LP compressor 112 and/or rotation of the fan shaft 128. The combustion gases 160 then exit the core turbine 104 through the exhaust section 122 thereof.

Along with the turbofan 100, the core turbine 104 serves a similar purpose and sees a similar environment in land-based gas turbines, turbojet engines in which the ratio of the first portion 146 of the air 142 to the second portion 148 of the air 142 is less than that of a turbofan, and unducted fan engines in which the fan section 106 is devoid of the nacelle 134. In each of the turbofan, turbojet, and unducted engines, a speed reduction device (e.g., the reduction gearbox 130) may be included between any shafts and spools. For example, the reduction gearbox 130 may be disposed between the LP shaft 126 and the fan shaft 128 of the fan section 106.

FIG. 2 is a schematic cross-sectional view of an example gas turbine engine with a conventional active clearance control (ACC) system 200. The ACC system 200 includes an example main pipe 205, an example high pressure turbine 210, an example low pressure turbine 215, example manifolds 220A, 220B, 220C, example flanges 225A, 225B, and example mid-rings 230A, 230B. In the illustrated example of FIG. 2, air from a fan (e.g., from the fan section 106) enters the main pipe 205, where the airflow in the main pipe 205 is shown by the arrows in FIG. 2. In some examples, the inlet of the main pipe 205 is located at the fan (e.g., the fan section 106 of FIG. 1) or upstream of a compressor (e.g., the HP compressor 114 of FIG. 1) for the high pressure turbine 210. In some examples, the ACC system 200 is applicable for a compressor (e.g., the HP compressor 114 and LP compressor 112 of FIG. 1) and the low pressure turbine 215. The main pipe 205 delivers the air from the fan to the manifolds 220A, 220B, 220C. The manifolds 220A, 220B, 220C evenly distribute the air from the fan to the high pressure turbine 210 and the low pressure turbine 215. In some examples, the high pressure turbine 210 is substantially similar to the HP turbine 118 and the low pressure turbine 215 is substantially similar to the LP turbine 120. The flanges 225A, 225B and mid-rings 230A, 230B are joined to the outer surfaces of the high pressure turbine 210 case and the low pressure turbine 215 case. The flanges 225A, 225B and mid-rings 230A, 230B are configured to contract radially inward and/or expand radially outward in responses to changes in temperature (e.g., changes in temperature caused by the air from the manifolds 220A, 220B, 220C). In some examples, at least some of the air is directed to impinge on the surfaces of the flanges 225A, 225B and mid-rings 230A, 230B. In some examples, the contraction inward and expansion outward of the flanges 225A, 225B and the mid-rings 230A, 230B can change blade tip clearances in the high pressure turbine 210 and the low pressure turbine 215.

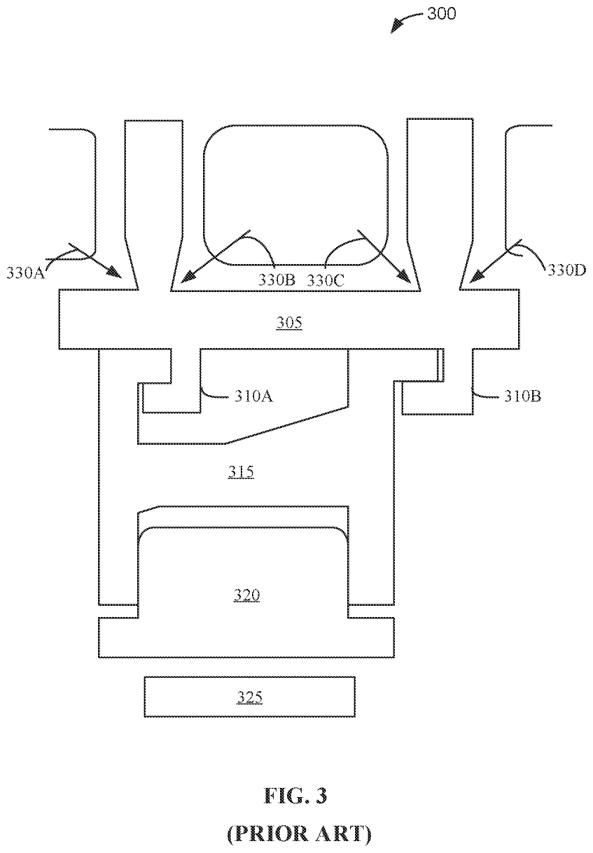

FIG. 3 is a schematic cross-sectional view of a prior ACC system 300 for the example gas turbine engine 100 of FIG. 1. The prior ACC system 300 includes a case 305, guiding hooks 310A, 310B, a hanger 315, a shroud 320, and a blade 325. In the illustrated example of FIG. 3, the case 305 is the casing surrounding either the HP turbine 118, the LP turbine 120, and/or the compressor (e.g., the HP compressor 114 and LP compressor 112 of FIG. 1). The case 305 includes the guiding hooks 310A, 310B, wherein the guiding hooks 310A, 310B connect the case 305 to the hanger 315. The hanger 315 is connected to the shroud 320.

In the illustrated example of FIG. 3, the prior ACC system 300 determines the clearance between the shroud 320 and the blade 325. The arrows 330A-330D in the prior ACC system 300 are representative of the cooling airflow from the main pipe 205 and manifolds 220A, 220B, 220C of the example FIG. 2. The prior ACC system 300 controls the movement of the shroud 320 in only one direction (e.g., inward towards the blade 325). The prior ACC system 300 uses the cooling airflow from the compressor or fan to cool the case 305. The case 305 shrinks (e.g., moves inward) as it is cooled by the airflow. The case 305 moves the hanger 315 and shroud 320 inward towards the blade 325. The prior ACC system 300 is unable to move the case 305, the hanger 315, and the shroud 320 for expansion. For example, the ACC system 300 is unable to expand the case 305 (e.g., move outward) to increase the clearance between the shroud 320 and the blade 325. In such examples, the prior ACC system 300 waits for clearance between the shroud 320 and the blade 325 to open (e.g., increase). The prior ACC system 300 does not provide bi-directional control of the clearance between the shroud 320 and the blade 325.

In some examples (e.g., the prior ACC system 300 of FIG. 3), an ACC system directs airflow around the case of an engine to control clearance between the case and the blade tip. For example, the ACC system controls the cooling airflow (represented as arrows 330A-330D in FIG. 3) from a compressor or fan to the case 305. In some examples, the ACC system mixes hot and cold air from a compressor and a bypass duct (contains turbofan airflow that bypassed the engine core) respectively to a desired temperature. In some examples, the ACC system helps to maintain and adjust the clearance between the engine case and the blade tip in prior ACC systems. In prior ACC systems (e.g., the prior ACC system 300 of FIG. 3), cooling airflow around the engine case (e.g., case 305) adjusts the clearance by controlling the thermal expansion and contraction of the case. In some examples, the ACC system controls the cooling airflow to either contract or expand the turbine engine case. For example, the prior ACC system 300 directs cooling airflow to the case 305 to contract the case 305 and restricts the cooling airflow to the case 305 to expand the case 305. The ACC system controls the cooling airflow to adjust the clearance to compensate any changes in the blade of the turbine engine. In some examples, the ACC system is controlled by a controller in the turbine engine (e.g., the FADEC). The FADEC sends electrical control signals to the ACC system to signal the ACC system to modulate the airflow to control the case thermal expansion. The ACC system ultimately controls the amount of cooling airflow to manage the turbine engine casing temperatures, thereby adjusting the blade tip clearance.

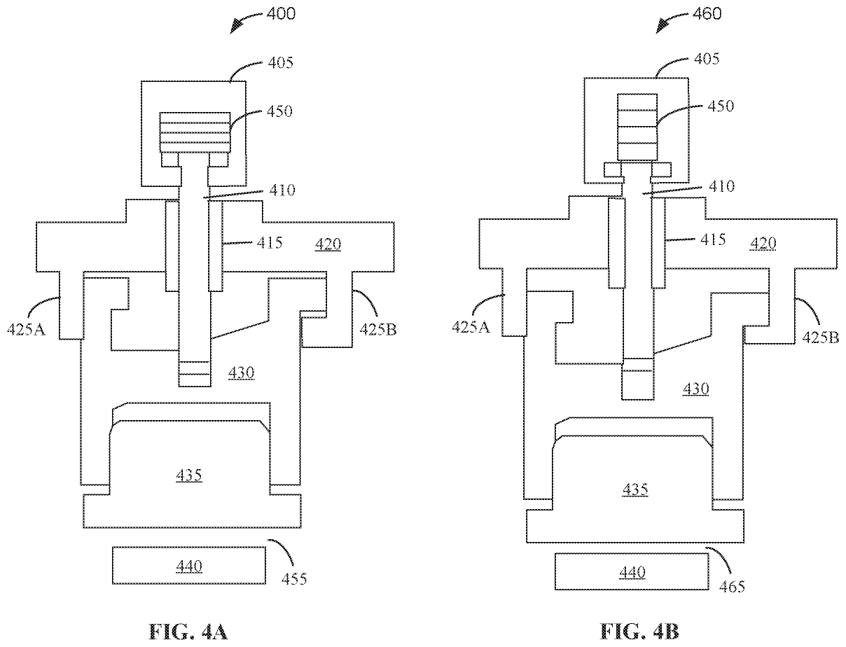

FIGS. 4A and 4B are schematic cross-sectional views of an example an ACC system 400 in accordance with teachings disclosed herein. The example ACC system 400 of FIG. 4A includes an actuator 405, a rod 410, a sealant 415, a case 420, a hanger 430, a shroud 435, and a blade 440. The actuator 405 includes a multilayer piezoelectric stack 450, for example. The example ACC system 400 of FIG. 4A includes an open clearance 455 between the shroud 435 and the blade 440.

FIG. 4B shows an alternative implementation of an ACC system 460. The example ACC system 460 of FIG. 4B includes the actuator 405, the rod 410, the sealant 415, the case 420, the hanger 430, the shroud 435, and the blade 440 of FIG. 4A. The actuator 405 of FIG. 4B includes the multilayer piezoelectric stack 450, which is expanded (or elongated) in the radial direction and contracted in the axial direction. The ACC system 460 of FIG. 4B includes a tight clearance 465 between the shroud 435 and the blade 440. In examples disclosed herein, the case 420 includes the guiding hooks 425A, 425B, wherein the guiding hooks 425A, 425B connect the case 420 to the hanger 430. The hanger 430 is connected to the shroud 435.

In the illustrated examples of FIGS. 4A and 4B, the actuator 405 is located outside of the case 420. In some examples, the case 420 is a case surrounding a high pressure turbine (e.g., the HP turbine 118 of FIG. 1), a low pressure turbine (e.g., the LP turbine 120 of FIG. 1), and/or a compressor (e.g., the HP compressor 114 and LP compressor 112 of FIG. 1). In some examples, locating the actuator 405 outside of the case 420 prevents material temperature limitations from affecting the actuator 405. For example, hot gas temperatures in a high pressure turbine such as the HP turbine 118 of FIG. 1, could cause material limitations for the actuator 405 if the actuator 405 was located inside the case 420. In the example ACC systems 400 and 460, the actuator 405 includes a multilayer stack of piezoelectric material 450. In some examples, the piezoelectric material of the multilayer stack of piezoelectric material 450 includes quartz, topaz, etc. However, other piezoelectric materials or other materials that generate linear displacement such as, shape memory alloy (SMA) materials, etc., can be additionally and/or alternatively included. In some examples, locating the actuator 405 and the multilayer stack of piezoelectric material 450 outside of the case 420 helps to preserve the piezoelectric material in a cold condition without concern of temperature limitations. The location of the actuator 405 and the multilayer stack of piezoelectric material 450 provides a benefit of easy access for maintenance and part replacement, for example.

In the illustrated examples of FIGS. 4A and 4B, the multilayer stack of piezoelectric material 450 is connected to the rod 410. The rod 410 is connected to the hanger 430 through the case 420. Since the actuator 405 and the multilayer stack of piezoelectric material 450 are located outside of the case 420, the rod 410 is inserted through the case to connect to the multilayer stack of piezoelectric material 450 and the hanger 430. In some examples, the opening in the case 420 for the rod 410 to be inserted through introduces possible leakage through the case 420. In such examples, the rod 410 is surrounded by the sealant 415 to seal the opening in the case 420 that the rod 410 is inserted through.

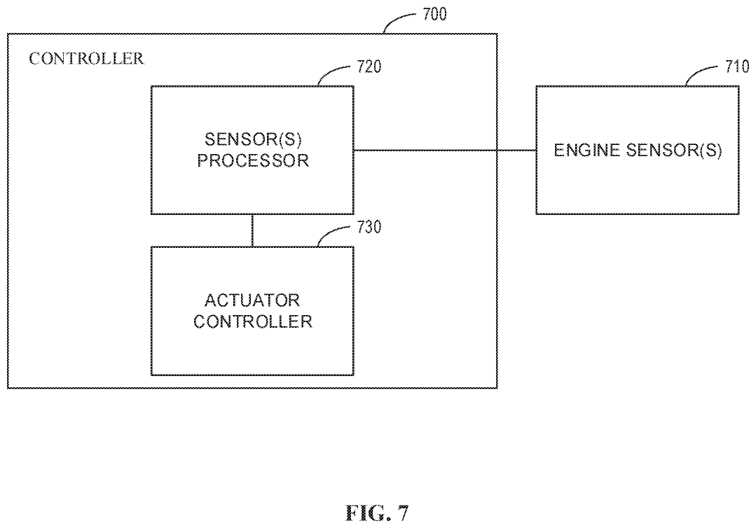

In the illustrated examples of FIGS. 4A and 4B, the multilayer stack of piezoelectric material 450 generates a linear displacement of the rod 410 from an electrical signal generated by an example controller. An example implementation of the controller that generates the electrical signal is illustrated in FIG. 7, which is described in further detail below. In some examples, the rod 410 moves the hanger 430 using the linear displacement generated by the multilayer stack of piezoelectric material 450. In the illustrated example, the hanger 430 and the shroud 435 are connected and move together. Therefore, in the illustrated example, the rod 410 moves the hanger 430 and the shroud 435 using the linear displacement generated by the multilayer stack of piezoelectric material 450. In some examples, the ACC system 400 includes the shroud 435 without the hanger 430. In such examples, the rod 410 moves the shroud 435 using the linear displacement generated by the multilayer stack of piezoelectric material 450. In some examples, the range of the linear displacement is increased by adding more layers of piezoelectric material to the multilayer stack of piezoelectric material 450. For example, adding layers in the multilayer stack of piezoelectric material 450, increase the radial movement range and muscle capability for the ACC system.

In the illustrated example of FIG. 4A, the ACC system 400 has an open clearance represented by the open clearance 455 between the shroud 435 and the blade 440. The multilayer stack of piezoelectric material 450 included in the actuator 405 controls the open clearance 455. In the ACC system 400, the actuator 405 receives a first electrical signal from an example controller, and the actuator 405 provides the first electrical signal to the multilayer stack of piezoelectric material 450. The first electrical signal causes a linear displacement of the multilayer stack of piezoelectric material 450 (e.g., each stack in the multilayer stack of piezoelectric material 450 is long and thin as seen in the example FIG. 4A). The linear displacement of the multilayer stack of piezoelectric material 450 moves the rod 410 upwards (e.g., away from the blade 440). The rod 410 moves the hanger 430 and shroud 435 upwards (e.g., away from the blade 440), which increases the open clearance 455.

The example ACC system 460 includes a tight clearance, indicated by the tight clearance 465 between the shroud 435 and the blade 440 shown in FIG. 4B. The multilayer stack of piezoelectric material 450 included in the actuator 405 controls the tight clearance 465. In the ACC system 460, the actuator 405 receives a second electrical signal from an example controller, and the actuator 405 provides the second electrical signal to the multilayer stack of piezoelectric material 450. The second electrical signal causes a linear displacement of the multilayer stack of piezoelectric material 450 (e.g., each stack in the multilayer stack of piezoelectric material 450 is short and thick as seen in the example FIG. 4B). The linear displacement of the multilayer stack of piezoelectric material 450 moves the rod 410 downwards (e.g., towards the blade 440). The rod 410 moves the hanger 430 and shroud 435 downwards (e.g., towards the blade 440), which decreases the tight clearance 465.

In the illustrated examples of FIGS. 4A and 4B, the actuator 405 adjusts the clearance in two directions (e.g., shrinkage and expansion). The actuator 405 can be installed for an individual shroud (e.g., the shroud 435), partial groups of shrouds (e.g., for groups of three shrouds, for groups of five shrouds, etc.), or for an entire group of shrouds in a turbine (e.g., the shrouds surrounding the 360 degree inner surface of the case 420).

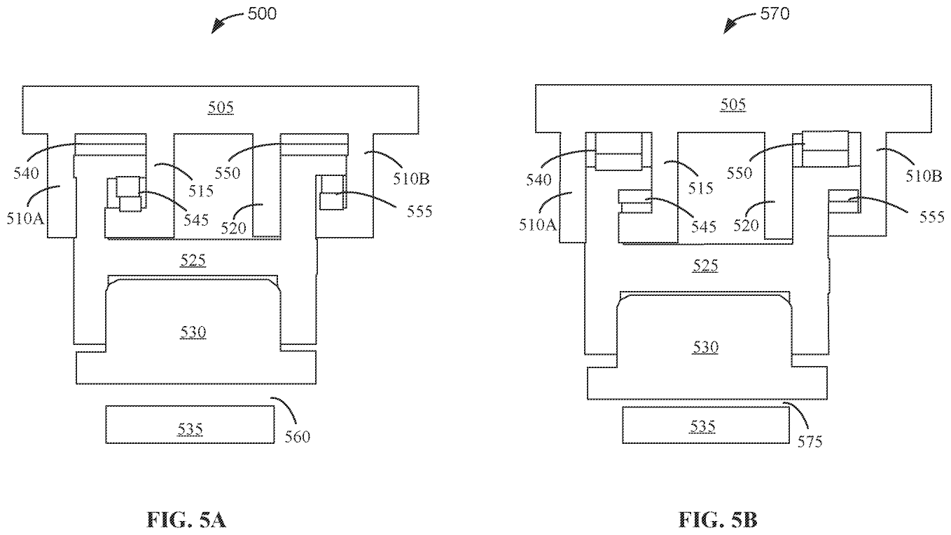

FIGS. 5A and 5B are schematic cross-sectional views of a second example implementation of an ACC system 500 in accordance with teachings disclosed herein. The example ACC system 500 of FIG. 5A includes a case 505, guiding hooks 510A, 510B, an actuator 515, an actuator 520, a hanger 525, a shroud 530, and a blade 535. The actuator 515 includes a multilayer stack of piezoelectric material 540 and a multilayer stack of piezoelectric material 545. The actuator 520 includes a multilayer stack of piezoelectric material 550 and a multilayer stack of piezoelectric material 555. The ACC system 500 includes an open clearance 560 between the shroud 530 and the blade 535. An example ACC system 570 of FIG. 5B includes the case 505, the guiding hooks 510A, 510B, the actuator 515, the actuator 520, the hanger 525, the shroud 530, and the blade 535 of FIG. 5A. The actuator 515 of FIG. 5B includes the multilayer stack of piezoelectric material 540 and the multilayer stack of piezoelectric material 545. The actuator 520 of FIG. 5B includes the multilayer stack of piezoelectric material 550 and the multilayer stack of piezoelectric material 555. The example ACC system 570 includes a tight clearance 575 between the shroud 530 and the blade 535. The case 505 includes the guiding hooks 510A, 510B, wherein the guiding hooks 510A, 510B connect the actuator 515 and the actuator 520 to the hanger 525. The hanger 525 is connected to the shroud 530.

In the illustrated examples of FIGS. 5A and 5B, the actuator 515 is located under the case 505 on the guiding hook 510A, and the actuator 520 is located under the case 505 on the guiding hook 510B. In some examples, the case 505 is a case surrounding a high pressure turbine (e.g., the HP turbine 118 of FIG. 1), a low pressure turbine (e.g., the LP turbine 120 of FIG. 1) or a compressor (e.g., the HP compressor 114 and LP compressor 112 of FIG. 1). In some examples, locating the actuator 515 and the actuator 520 under the case 505 reduces sealing concerns prevalent in the example ACC systems 400 and 460 of FIGS. 4A and 4B respectively, as described above. However, the location of the actuator 515 and the actuator 520 prevents easy access for maintenance and part replacement. In the illustrated example ACC systems 500 and 570, the actuator 515 includes the multilayer stack of piezoelectric material 540 and the multilayer stack of piezoelectric material 545. In the illustrated example ACC systems 500 and 570, the actuator 520 includes the multilayer stack of piezoelectric material 550 and the multilayer stack of piezoelectric material 555. In some examples, the piezoelectric material of the multilayer stacks of piezoelectric material 540, 545, 550, 555 can include quartz, topaz, etc. However, other piezoelectric materials or other materials that generate linear displacement, such as shape memory alloy (SMA) materials, etc., can be additionally and/or alternatively included.

In the illustrated examples of FIGS. 5A and 5B, the hanger 525 extends into the actuator 515 and the actuator 520. The multilayer stacks of piezoelectric material 540, 545, 550, 555 are connected to the hanger 525 extensions. The multilayer stack of piezoelectric material 540 is connected to a top surface of the hanger 525 extension in the actuator 515. The multilayer stack of piezoelectric material 545 is connected to a bottom surface of the hanger 525 extension in the actuator 515. The multilayer stack of piezoelectric material 550 is connected to a top surface of the hanger 525 extension in the actuator 520. The multilayer stack of piezoelectric material 555 is connected to a bottom surface of the hanger 525 extension in the actuator 520.

In the illustrated examples of FIGS. 5A and 5B, the multilayer stacks of piezoelectric material 540, 545, 550, 555 generate a linear displacement of the hanger 525 from electrical signals generated by an example controller. An example controller that generates the electrical signal is illustrated in FIG. 7, which is described in further detail below. In the examples of FIGS. 5A and 5B, the hanger 525 and the shroud 530 are connected and move together. As such, the hanger 525 moves the shroud 530 using the linear displacement generated by the multilayer stacks of piezoelectric material 540, 545, 550, 555. In some examples, the ACC system 500 includes the shroud 530 without the hanger 525. In such examples, the shroud 530 moves using the linear displacement generated by the multilayer stacks of piezoelectric material 540, 545, 550, 555. The multilayer stacks of piezoelectric material 540, 545, 550, 555 are positioned on a top surface and a bottom surface of the hanger 525 extensions in the actuator 515 and the actuator 520 to accurately modulate the linear displacement. In some examples, the range of the linear displacement is increased by adding more layers of piezoelectric material to the multilayer stacks of piezoelectric material 540, 545, 550, 555. For example, the more layers added in the multilayer stacks of piezoelectric material 540, 545, 550, 555, the more radial movement range and muscle capability for the ACC system.

The example ACC system 500 has an open clearance represented by the open clearance 560 between the shroud 530 and the blade 535. The multilayer stacks of piezoelectric material 540, 545, 550, 555 control the open clearance 560. In the ACC system 500, the actuator 515 and the actuator 520 receive a first electrical signal from an example controller. The actuator 515 provides the first electrical signal to the multilayer stack of piezoelectric material 540, and actuator 520 provides the first electrical signal to the multilayer stack of piezoelectric material 550. The first electrical signal causes a linear displacement of the multilayer stack of piezoelectric material 540 (e.g., each stack in the multilayer stack of piezoelectric material 540 is long and thin as seen in the example FIG. 5A) and the multilayer stack of piezoelectric material 550 (e.g., each stack in the multilayer stack of piezoelectric material 550 is long and thin as seen in the example FIG. 5A).

In the ACC system 500, the actuator 515 and the actuator 520 receive a second electrical signal from an example controller. In some examples, the actuator 515 receives the first electrical signal and the second electrical signal at the same time or at substantially the same time given transmission delay (e.g., in parallel). The actuator 515 provides the second electrical signal to the multilayer stack of piezoelectric material 545, and actuator 520 provides the second electrical signal to the multilayer stack of piezoelectric material 555. The second electrical signal causes a linear displacement of the multilayer stack of piezoelectric material 545 (e.g., each stack in the multilayer stack of piezoelectric material 545 is short and thick as seen in the example FIG. 5A) and the multilayer stack of piezoelectric material 555 (e.g., each stack in the multilayer stack of piezoelectric material 555 is short and thick as seen in the example FIG. 5A). The linear displacement of the multilayer stacks of piezoelectric material 540, 545, 550, 555 move the hanger 525 and shroud 530 upwards (e.g., away from the blade 535), which increases the open clearance 560.

In the example of FIG. 5B, the ACC system 570 has a tight clearance represented by the tight clearance 575 between the shroud 530 and the blade 535. The multilayer stacks of piezoelectric material 540, 545, 550, 555 control the tight clearance 575. In the ACC system 570, the actuator 515 and the actuator 520 receive a third electrical signal from an example controller. The actuator 515 provides the third electrical signal to the multilayer stack of piezoelectric material 540, and actuator 520 provides the third electrical signal to the multilayer stack of piezoelectric material 550. The third electrical signal causes a linear displacement of the multilayer stack of piezoelectric material 540 (e.g., each stack in the multilayer stack of piezoelectric material 540 is short and thick as seen in the example FIG. 5B) and the multilayer stack of piezoelectric material 550 (e.g., each stack in the multilayer stack of piezoelectric material 550 is short and thick as seen in the example FIG. 5B).

In the ACC system 570, the actuator 515 and the actuator 520 receive a fourth electrical signal from an example controller. In some examples, the actuator 520 receives the third electrical signal and the fourth electrical signal at the same time or at substantially the same time given transmission delay (e.g., in parallel). The actuator 515 provides the fourth electrical signal to the multilayer stack of piezoelectric material 545, and actuator 520 provides the fourth electrical signal to the multilayer stack of piezoelectric material 555. The fourth electrical signal causes a linear displacement of the multilayer stack of piezoelectric material 545 (e.g., each stack in the multilayer stack of piezoelectric material 545 is long and thin as seen in the example FIG. 5B) and the multilayer stack of piezoelectric material 555 (e.g., each stack in the multilayer stack of piezoelectric material 555 is long and thin as seen in the example FIG. 5B). The linear displacement of the multilayer stacks of piezoelectric material 540, 545, 550, 555 move the hanger 525 and shroud 530 downward (e.g., towards the blade 535), which decreases the tight clearance 575.

In the illustrated examples of FIGS. 5A and 5B, the actuator 515 and the actuator 520 adjust the clearance between the shroud 530 and the blade 535 in two directions (e.g., shrinkage and expansion). The actuator 515 and the actuator 520 can be installed for an individual shroud (e.g., the shroud 530), partial groups of shrouds (e.g., for groups of three shrouds, for groups of five shrouds, etc.), or for an entire group of shrouds in a turbine (e.g., the shrouds surrounding the 360 degree inner surface of the case 505).

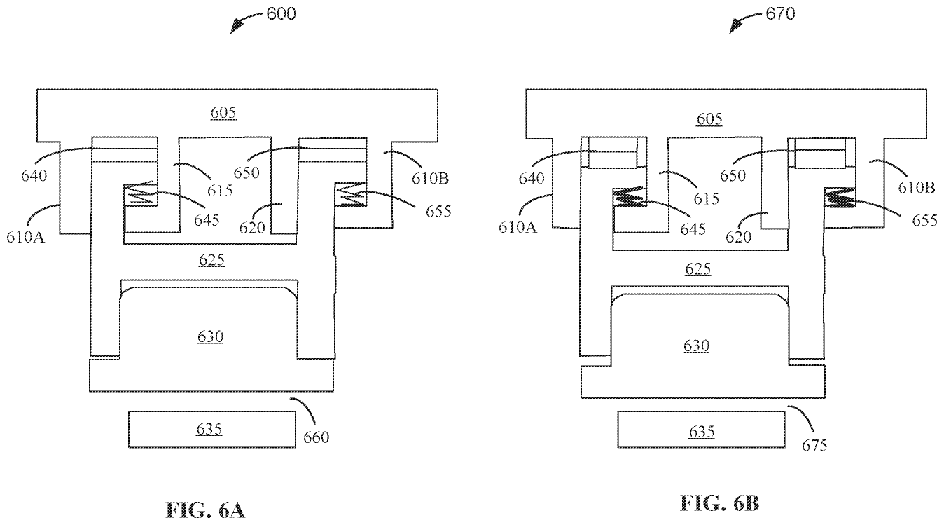

FIGS. 6A and 6B are schematic cross-sectional views of a third example implementation of an ACC system 600, 670 in accordance with teachings disclosed herein. The example ACC system 600 of FIG. 6A includes an example case 605, example guiding hooks 610A, 610B, an example actuator 615, an example actuator 620, an example hanger 625, an example shroud 630, and an example blade 635. The actuator 615 includes an example piezoelectric stack 640 and an example spring 645. The actuator 620 includes an example piezoelectric stack 650 and an example spring 655. The ACC system 600 includes an example clearance 660 between the shroud 630 and the blade 635. The example ACC system 670 of FIG. 6B includes the case 605, the guiding hooks 610A, 610B, the actuator 615, the actuator 620, the hanger 625, the shroud 630, and the blade 635 of FIG. 6A. The actuator 615 of FIG. 6B includes the piezoelectric stack 640 and the spring 645. The example actuator 620 of FIG. 6B includes the piezoelectric stack 650 and the spring 655. The ACC system 670 includes an example clearance 675 between the shroud 630 and the blade 635.

In the illustrated examples of FIGS. 6A and 6B, the actuator 615 is located under the case 605 on the guiding hook 610A, and the actuator 620 is located under the case 605 on the guiding hook 610B. In some examples, the case 605 is a case surrounding a high pressure turbine (e.g., the HP turbine 118 of FIG. 1), a low pressure turbine (e.g., the LP turbine 120 of FIG. 1), or a compressor (e.g., the HP compressor 114 and LP compressor 112 of FIG. 1). In some examples, locating the actuator 615 and the actuator 620 under the case 605 reduces sealing concerns prevalent in the example ACC systems 400 and 460 of FIGS. 4A and 4B respectively, as described above. However, the location of the actuator 615 and the actuator 620 prevents easy access for maintenance and part replacement. In the example ACC systems 600 and 670, the actuator 615 includes the multilayer stack of piezoelectric material 640 and the spring 645. In the example ACC systems 600 and 670, the actuator 620 includes the multilayer stack of piezoelectric material 650 and the spring 655. In some examples, the piezoelectric material of the multilayer stacks of piezoelectric material 640, 650 can include quartz, topaz, etc. However, other piezoelectric materials or other materials that generate linear displacement, such as shape memory alloy (SMA) materials, etc., can be additionally and/or alternatively included. The multilayer stack of piezoelectric material 640 and the multilayer stack of piezoelectric material 650 each receive control electrical signals to operate in the ACC systems 600 and 670. The actuator 615 and the actuator 620 include springs 645, 655 instead of additional multilayer stacks of piezoelectric material because the springs reduce the controls complexity for the actuators 615, 620 (e.g., including the springs 645, 655 allows for the actuator 615 and the actuator 620 to only have to receive one electrical control signal each). However, the springs 645, 655 may cause uncertainty in linear displacement modulation in the example ACC system 600, 670 as compared to the example ACC system 500, 570.

In the illustrated examples of FIGS. 6A and 6B, the hanger 625 extends into the actuator 615 and the actuator 620. The multilayer stacks of piezoelectric material 640, 650 and the springs 645, 655 are connected to the hanger 625 extensions. The multilayer stack of piezoelectric material 640 is connected to a top surface of the hanger 625 extension in the actuator 615. The spring 645 is connected to a bottom surface of the hanger 625 extension in the actuator 615. The multilayer stack of piezoelectric material 650 is connected to a top surface of the hanger 625 extension in the actuator 620. The spring 655 is connected to a bottom surface of the hanger 625 extension in the actuator 620.

In the illustrated examples of FIGS. 6A and 6B, the multilayer stacks of piezoelectric material 640, 650 generate a linear displacement of the hanger 625 from electrical signals generated by an example controller. An example controller that generates the electrical signal is illustrated in FIG. 7, which is described in further detail below. The springs 645, 655 provide a load for the bottom surface of the hanger 625 extensions based on the linear displacement of the multilayer stacks of piezoelectric material 640, 650. In the illustrated example of FIGS. 6A and 6B, the hanger 625 and the shroud 630 are connected and move together. As such, the hanger 625 moves the shroud 630 using the linear displacement generated by the multilayer stacks of piezoelectric material 640, 650. In some examples, the ACC system 600 includes the shroud 630 without the hanger 625. In such examples, the shroud 630 moves using the linear displacement generated by the multilayer stacks of piezoelectric material 640, 650. The multilayer stacks of piezoelectric material 640, 650 are positioned on a top surface of the hanger 625 extensions in the actuator 615 and the actuator 620 to accurately modulate the linear displacement. The springs 645, 655 are positioned on a bottom surface of the hanger 625 extensions in the actuator 615 and the actuator 620 to provide a spring load to the hanger 625 based on the linear displacement generated by the multilayer stacks of piezoelectric material 640, 650. In some examples, the range of the linear displacement is increased by adding more layers of piezoelectric material to the multilayer stacks of piezoelectric material 640, 650. For example, the more layers added in the multilayer stacks of piezoelectric material 640, 650 the more radial movement range and muscle capability for the ACC system.

In the illustrated example of FIG. 6A, the ACC system 600 has an open clearance represented by the open clearance 660 between the shroud 630 and the blade 635. The multilayer stacks of piezoelectric material 640, 650 control the open clearance 660. In the ACC system 600, the actuator 615 and the actuator 620 receive a first electrical signal from an example controller. The actuator 615 provides the first electrical signal to the multilayer stack of piezoelectric material 640, and actuator 620 provides the first electrical signal to the multilayer stack of piezoelectric material 650. The first electrical signal causes a linear displacement of the multilayer stack of piezoelectric material 640 (each stack in the multilayer stack of piezoelectric material 640 is long and thin as seen in the example FIG. 6A) and the multilayer stack of piezoelectric material 650 (each stack in the multilayer stack of piezoelectric material 650 is long and thin as seen in the example FIG. 6A). The springs 645, 655 provide a spring load to match the linear displacement of the multilayer stacks of piezoelectric material 640, 650. For example, the springs 645, 655 extend to provide a load to match the change in linear displacement from the multilayer stacks of piezoelectric material 640, 650. The linear displacement of the multilayer stacks of piezoelectric material 640, 650 and the loads from the springs 645, 655 move the hanger 625 and shroud 630 upwards (e.g., away from the blade 635), which increases the open clearance 660.

In the illustrated example of FIG. 6B, the ACC system 670 has a tight clearance represented by the tight clearance 675 between the shroud 630 and the blade 635. The multilayer stacks of piezoelectric material 640, 650 and the springs 645, 655 control the tight clearance 675. In the ACC system 670, the actuator 615 and the actuator 620 receive a second electrical signal from an example controller. The actuator 615 provides the second electrical signal to the multilayer stack of piezoelectric material 640, and actuator 620 provides the second electrical signal to the multilayer stack of piezoelectric material 650. The second electrical signal causes a linear displacement of the multilayer stack of piezoelectric material 640 (e.g., each stack in the multilayer stack of piezoelectric material 640 is short and thick as seen in the example FIG. 6B) and the multilayer stack of piezoelectric material 650 (e.g., each stack in the multilayer stack of piezoelectric material 650 is short and thick as seen in the example FIG. 6B). The springs 645, 655 provide a spring load to match the linear displacement of the multilayer stacks of piezoelectric material 640, 650. For example, the springs 645, 655 compress to provide a load to match the change in linear displacement from the multilayer stacks of piezoelectric material 640, 650. The linear displacement of the multilayer stacks of piezoelectric material 640, 650 and the loads from the springs 645, 655 move the hanger 625 and shroud 630 downward (e.g., towards the blade 635), which decreases the tight clearance 675.

In the illustrated examples of FIGS. 6A and 6B, the actuator 615 and the actuator 620 adjust the clearance between the shroud 630 and the blade 635 in two directions (e.g., shrinkage and expansion). The actuator 615 and the actuator 620 can be installed for an individual shroud (e.g., the shroud 630), partial groups of shrouds (e.g., for groups of three shrouds, for groups of five shrouds, etc.), or for an entire group of shrouds in a turbine (e.g., the shrouds surrounding the 360 degree inner surface of the case 605).

FIG. 7 is a block diagram of an example controller 700 of an example ACC system 400-670 in accordance with the examples disclosed herein. In FIG. 7, the controller 700 can be a full-authority digital engine control (FADEC) unit, an engine control unit (ECU), an electronic engine control (EEC) unit, etc., or any other type of data acquisition and/or control computing device, processor platform (e.g., processor-based computing platform), etc. The controller 700 communicates with the example engine sensor(s) 710. The controller 700 includes an example sensor(s) processor 720 and an example actuator controller 730.

In the illustrated example of FIG. 7, the controller 700 receives values for a plurality of input variables relating to flight condition (e.g., air density, throttle lever position, engine temperatures, engine pressures, direct clearance measurements, indirect clearance measurements, etc.). The controller 700 receives the flight condition data from the engine sensor(s) 710. The engine sensor(s) 710 can be mounted on the gas turbine engine 100 and/or positioned elsewhere in the aircraft (e.g., on wing, in cockpit, in main cabin, in engine compartment, in cargo, etc.). The communication between the controller 700 and the engine sensor(s) 710 can be one-way communication and/or two-way communication, for example. The controller 700 computes engine operating parameters such as fuel flow, stator vane position, air bleed valve position, etc., using the flight condition data.

In the illustrated example of FIG. 7, the sensor(s) processor 720 obtains the sensor data from the example engine sensor(s) 710. The sensor data includes the flight condition data obtained from the gas turbine engine 100. The sensor(s) processor 720 monitors engine conditions based on the sensor data from the engine sensor(s) 710. For example, the sensor(s) processor 720 can calculate and monitor the fuel flow, stator vane position, air bleed valve position, etc. In some examples, the sensor(s) processor 720 determines if the turbine case is expanding or shrinking based on the engine conditions determined from the obtained flight condition data. In the illustrated example of FIG. 7, the actuator controller 730 generates electrical signals to the actuator(s) of an ACC system. In some examples, the actuator controller 730 generates an electrical control signal to the actuator(s) of an ACC system 400-670 based on the results from sensor(s) processor 720.

For the example ACC systems 400 and 460 of FIGS. 4A and 4B respectively, the actuator controller 730 generates and sends a first electrical current via a first electrical signal to the multilayer stack of piezoelectric material 450 located in the actuator 405. In some examples, the actuator controller 730 sends the first electrical current to the actuator 405 when the sensor(s) processor 720 determines that the turbine case is expanding. In some examples, the first electrical current causes a linear displacement in the multilayer stack of piezoelectrical material 450 that moves the shroud 435 towards the blade 440 (similar to the example ACC system 460 of FIG. 4B). However, the actuator controller 730 can send the first electrical current to the actuator 405 for additional and/or alternative flight conditions (e.g., flight conditions other than those indicative of turbine case expansion) determined by the sensor(s) processor 720. In other examples, the actuator controller 730 generates and sends a second electrical current via a second electrical signal to the multilayer stack of piezoelectric material 450 located in the actuator 405. In some examples, the actuator controller 730 sends the second electrical current to the actuator 405 when the sensor(s) processor 720 determines that the turbine case is shrinking. In some examples, the second electrical current causes a linear displacement in the multilayer stack of piezoelectrical material 450 that moves the shroud 435 away from the blade 440 (similar to the example ACC system 400 of FIG. 4A). However, the actuator controller 730 can send the second electrical current to the actuator 405 for additional and/or alternative flight conditions (e.g., flight conditions other than those indicative of turbine case shrinkage) determined by the sensor(s) processor 720.

For the example ACC systems 500 and 570 of FIGS. 5A and 5B respectively, the actuator controller 730 generates and sends a first electrical current via a first electrical signal to the multilayer stack of piezoelectric material 540 and the multilayer stack of piezoelectric material 550 located in the actuator 515 and the actuator 520 respectively. The actuator controller 730 also generates and sends a second electrical current via a second electrical signal to the multilayer stack of piezoelectric material 545 and the multilayer stack of piezoelectric material 555 located in the actuator 515 and the actuator 520, respectively. In some examples, the actuator controller sends the first electrical current and the second electrical current to the actuator 515 and the actuator 520 when the sensor(s) processor 720 determines that the turbine case is expanding. In some examples, the first electrical current causes a first linear displacement in the multilayer stack of piezoelectrical material 540 and the multilayer stack of piezoelectric material 550. In some examples, the second electrical current causes a second linear displacement in the multilayer stack of piezoelectrical material 545 and the multilayer stack of piezoelectric material 555. In some examples, the second linear displacement is opposite of the first linear displacement. For example, if the first linear displacement is an increase in length and a decrease in thickness of the multilayer stack of piezoelectrical material 540 and the multilayer stack of piezoelectric material 550, then the second linear displacement is a decrease in length and an increase in thickness of the multilayer stack of piezoelectrical material 545 and the multilayer stack of piezoelectric material 555. The first linear displacement and the second linear displacement move the shroud 530 towards the blade 535 (similar to the example ACC system 570 of FIG. 5B). However, the actuator controller 730 can send the first electrical current and the second electrical current to the actuator 515 and the actuator 520 for additional and/or alternative flight conditions (e.g., flight conditions other than those indicative of case shrinkage) determined by the sensor(s) processor 720.

In other examples, the actuator controller 730 generates and sends a third electrical current via a third electrical signal to the multilayer stack of piezoelectric material 540 and the multilayer stack of piezoelectric material 550. The actuator controller 730 also generates and sends a fourth electrical current via a fourth electrical signal to the multilayer stack of piezoelectric material 545 and the multilayer stack of piezoelectric material 555. In some examples, the actuator controller sends the third electrical current and the fourth electrical current to the actuator 515 and the actuator 520 when the sensor(s) processor 720 determines that the case is shrinking. In some examples, the third electrical current causes a third linear displacement in the multilayer stack of piezoelectrical material 540 and the multilayer stack of piezoelectric material 550. In some examples, the fourth electrical current causes a fourth linear displacement in the multilayer stack of piezoelectrical material 545 and the multilayer stack of piezoelectric material 555. In some examples, the fourth linear displacement is opposite of the third linear displacement. For example, if the third linear displacement is a decrease in length and an increase in thickness of the multilayer stack of piezoelectrical material 540 and the multilayer stack of piezoelectric material 550, then the fourth linear displacement is an increase in length and a decrease in thickness of the multilayer stack of piezoelectrical material 545 and the multilayer stack of piezoelectric material 555. The third linear displacement and the fourth linear displacement move the shroud 530 towards the blade 535 (similar to the example ACC system 500 of FIG. 5A). However, the actuator controller 730 can send the third electrical current and the fourth electrical current to the actuator 515 and the actuator 520 for additional and/or alternative flight conditions (e.g., flight conditions other than those indicative of case shrinkage) determined by the sensor(s) processor 720.

For the example ACC systems 600 and 670 of FIGS. 6A and 6B respectively, the actuator controller 730 generates and sends a first electrical current via a first electrical signal to the multilayer stack of piezoelectric material 640 and the multilayer stack of piezoelectric material 650 located in the actuator 615 and the actuator 620 respectively. In some examples, the actuator controller 730 sends the first electrical current to the actuator 615 and the actuator 620 when the sensor(s) processor 720 determines that the case is expanding. In some examples, the first electrical current causes a linear displacement in the multilayer stack of piezoelectrical material 640 and the multilayer stack of piezoelectrical material 650 that moves the shroud 630 towards the blade 635 (similar to the example ACC system 670 of FIG. 6B). However, the actuator controller 730 can send the first electrical current to the actuator 615 and the actuator 620 for additional and/or alternative flight conditions (e.g., flight conditions other than those indicative of case expansion) determined by the sensor(s) processor 720. In some examples, the actuator controller 730 generates and sends a second electrical current via a second electrical signal to the multilayer stack of piezoelectric material 640 and the multilayer stack of piezoelectric material 650 located in the actuator 615 and the actuator 620, respectively. In some examples, the actuator controller 730 sends the second electrical current to the actuator 615 and the actuator 620 when the sensor(s) processor 720 determines that the case is shrinking. In some examples, the second electrical current causes a linear displacement in the multilayer stack of piezoelectrical material 640 and the multilayer stack of piezoelectrical material 650 that moves the shroud 630 away from the blade 635 (similar to the example ACC system 600 of FIG. 6A). However, the actuator controller 730 can send the second electrical current to the actuator 615 and the actuator 620 for additional and/or alternative flight conditions (e.g., flight conditions other than those indicative of turbine case shrinkage) determined by the sensor(s) processor 720.

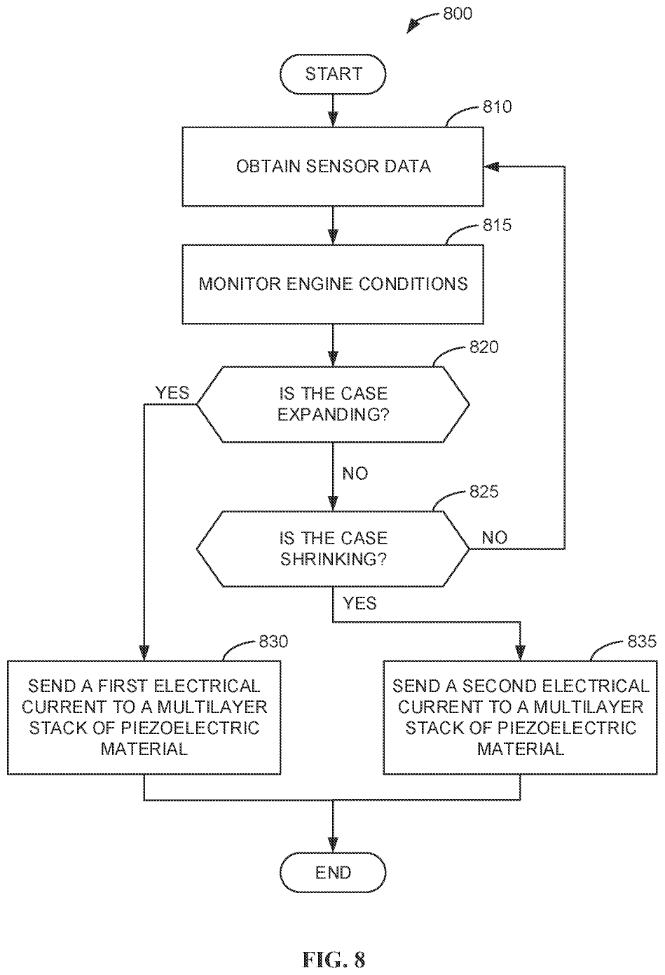

While an example manner of implementing the controller 700 of FIG. 7 is illustrated in FIGS. 8, 9, and 10, one or more of the elements, processes and/or devices illustrated in FIGS. 8, 9, and 10 may be combined, divided, re-arranged, omitted, eliminated and/or implemented in any other way. Further, the example sensor(s) processor 720, the example actuator controller 725 and/or, more generally, the example controller 700 of FIG. 7 may be implemented by hardware, software, firmware and/or any combination of hardware, software and/or firmware. Thus, for example, any of the example sensor(s) processor 720, the example actuator controller 725 and/or, more generally, the example controller 700 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example sensor(s) processor 720 and/or the example actuator controller 725 is/are hereby expressly defined to include a non-transitory computer readable storage device or storage disk such as a memory, a compact disk (CD), etc. including the software and/or firmware. Further still, the example controller 700 of FIG. 7 may include one or more elements, processes and/or devices in addition to, or instead of, those illustrated in FIGS. 8, 9, and 10, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

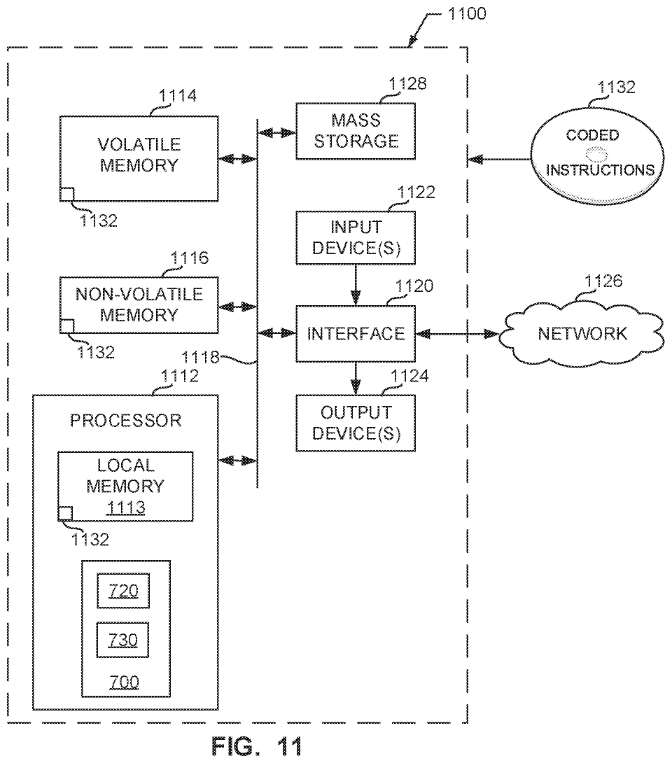

A flowchart representative of example hardware logic, machine readable instructions, hardware implemented state machines, and/or any combination thereof for implementing the controller 700 of FIG. 7 is shown in FIGS. 8, 9, and 10. The machine readable instructions may be one or more executable programs or portion(s) of an executable program for execution by a computer processor and/or processor circuitry, such as the processor 1212 shown in the example processor platform 1200 discussed below in connection with FIG. 11. The program may be embodied in software stored on a non-transitory computer readable storage medium such as a CD-ROM, a floppy disk, a hard drive, or a memory associated with the processor 1212, but the entire program and/or parts thereof could alternatively be executed by a device other than the processor 1212 and/or embodied in firmware or dedicated hardware. Further, although the example program is described with reference to the flowchart illustrated in FIGS. 8, 9, and 10, many other methods of implementing the example controller 700 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 8, 9, and 10 can be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 8 is a flowchart representative of machine readable instructions that can be executed to implement the example controller 700 of FIG. 7 in conjunction with the example ACC system of FIGS. 4A, 4B. The program 800 of FIG. 8 begins execution at block 810 at which the example sensor(s) processor 720 obtains sensor data from the example engine sensor(s) 710. In some examples, the sensor data includes the flight condition data obtained by the engine sensor(s) 710 from an engine (e.g., the gas turbine engine 100 of FIG. 1). In some examples, flight condition data of the sensor data includes values for a plurality of input variables relating to flight conditions (e.g., air density, throttle lever position, engine temperatures, engine pressures, etc.).

At block 815, the example sensor(s) processor 720 monitors engine conditions based on the sensor data from the engine sensor(s) 710. For example, the sensor(s) processor 720 can calculate and monitor the fuel flow, stator vane position, air bleed valve position, etc., using the flight condition data included in the sensor data. At block 820, the example sensor(s) processor 720 determines if the case is expanding. In some examples, the case is a case surrounding a high pressure turbine (e.g., the HP turbine 118 of FIG. 1), a low pressure turbine (e.g., the LP turbine 120 of FIG. 1), and/or a compressor (e.g., the HP compressor 114 and LP compressor 112 of FIG. 1) forming part of a turbine engine. In some examples, the sensor(s) processor 720 determines if the case is expanding based on the engine conditions determined from the obtained flight condition data. If the example sensor(s) processor 720 determines that the case is expanding, then the example program 800 continues to block 830 at which the example actuator controller 730 sends a first electrical current to a multilayer stack of piezoelectric material. If the example sensor(s) processor 720 determines that the case is not expanding, then the example program 800 continues to block 825 at which the example sensor(s) processor 720 determines if the case is shrinking.

At block 825, the example sensor(s) processor 720 determines if the case is shrinking. In some examples, the sensor(s) processor 720 determines if the case is shrinking based on the engine conditions determined from the obtained flight condition data. If the example sensor(s) processor 720 determines that the case is shrinking, then the example program 800 continues to block 835 at which the example actuator controller 730 sends a second electrical current to a multilayer stack of piezoelectric material. If the example sensor(s) processor 720 determines that the case is not shrinking, then the example program 800 returns to block 810 at which the example sensor(s) processor 720 obtains sensor data.

At block 830, the example actuator controller 730 sends a first electrical current to a multilayer stack of piezoelectric material. In some examples, the actuator controller 730 generates and sends the first electrical current via a first electrical signal to the multilayer stack of piezoelectric material 450 located in the actuator 405 of FIGS. 4A and 4B. In some examples, the first electrical current causes a linear displacement in the multilayer stack of piezoelectrical material 450 that moves the shroud 435 towards the blade 440 (similar to the example ACC system 460 of FIG. 4B). After the example actuator controller 730 sends the first electrical current, the program 800 ends.

At block 835, the example actuator controller 730 sends a second electrical current to a multilayer stack of piezoelectric material. In some examples, the multilayer stack of piezoelectric material is substantially similar to the multilayer stack of piezoelectric material 450 of FIGS. 4A, 4B. In some examples, the actuator controller 730 generates and sends the second electrical current via a second electrical signal to the multilayer stack of piezoelectric material 450 located in the actuator 405. In some examples, the second electrical current causes a linear displacement in the multilayer stack of piezoelectrical material 450 that moves the shroud 435 away from the blade 440 (similar to the example ACC system 400 of FIG. 4A). After the example actuator controller 730 sends the second electrical current, the program 800 ends.

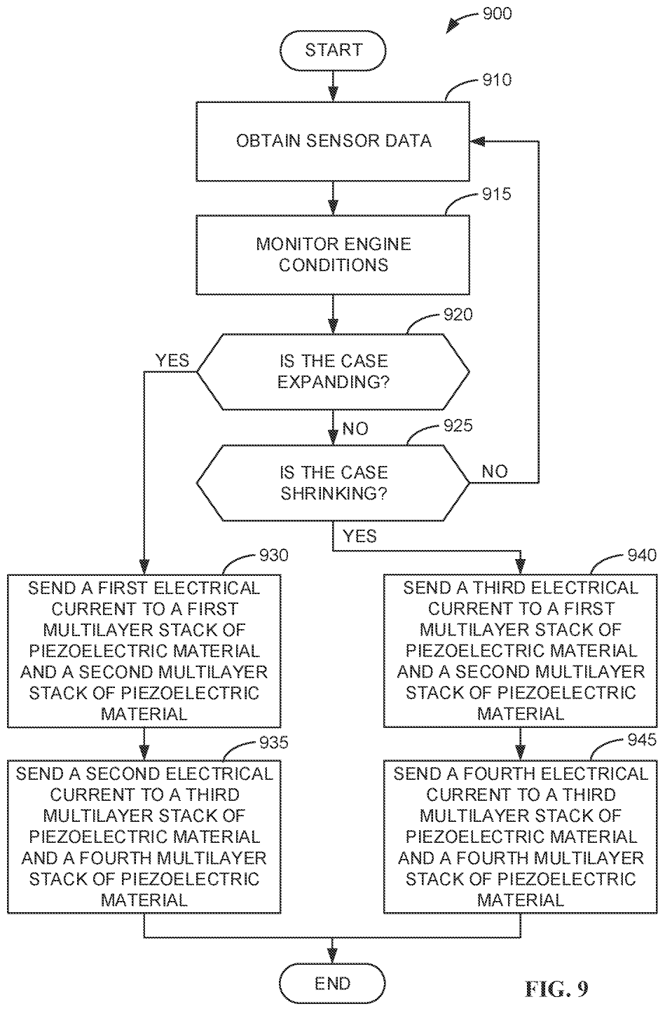

FIG. 9 is a flowchart representative of machine readable instructions that can be executed to implement the example controller 700 of FIG. 7 in conjunction with the example ACC system of FIGS. 5A, 5B. The program 900 of FIG. 9 begins execution at block 910 at which the example sensor(s) processor 720 obtains sensor data from the example engine sensor(s) 710. In some examples, the sensor data includes the flight condition data obtained by the engine sensor(s) 710 from an engine (e.g., the gas turbine engine 100 of FIG. 1). In some examples, flight condition data of the sensor data includes values for a plurality of input variables relating to flight conditions (e.g., air density, throttle lever position, engine temperatures, engine pressures, etc.).

At block 915, the example sensor(s) processor 720 monitors engine conditions based on the sensor data from the engine sensor(s) 710. For example, the sensor(s) processor 720 can calculate and monitor the fuel flow, stator vane position, air bleed valve position, etc., using the flight condition data included in the sensor data. At block 920, the example sensor(s) processor 720 determines if the case is expanding. In some examples, the case is a case surrounding a high pressure turbine (e.g., the HP turbine 118 of FIG. 1), a low pressure turbine (e.g., the LP turbine 120 of FIG. 1) or a compressor (e.g., the HP compressor 114 and LP compressor 112 of FIG. 1). In some example, the sensor(s) processor 720 determines if the case is expanding based on the engine conditions determined from the obtained flight condition data. If the example sensor(s) processor 720 determines that the turbine case is expanding, then the example program 900 continues to block 930 at which the example actuator controller 730 sends a first electrical current to a first multilayer stack of piezoelectric material and a second multilayer stack of piezoelectric material. If the example sensor(s) processor 720 determines that the case is not expanding, then the example program 900 continues to block 925 at which the example sensor(s) processor 720 determines if the case is shrinking.

At block 925, the example sensor(s) processor 720 determines if the case is shrinking. In some example, the sensor(s) processor 720 determines if the case is shrinking based on the engine conditions determined from the obtained flight condition data. If the example sensor(s) processor 720 determines that the case is shrinking, then the example program 900 continues to block 940 at which the example actuator controller 730 sends a third electrical current to a first multilayer stack of piezoelectric material and a second multilayer stack of piezoelectric material. If the example sensor(s) processor 720 determines that the case is not shrinking, then the example program 900 returns to block 910 at which the example sensor(s) processor 720 obtains sensor data.

At block 930, the example actuator controller 730 sends a first electrical current to a first multilayer stack of piezoelectric material and a second multilayer stack of piezoelectric material. In some examples, the first multilayer stack of piezoelectric material is substantially similar to the multilayer stack of piezoelectric material 540, and the second multilayer stack of piezoelectric material is substantially similar to the multilayer stack of piezoelectric material 550. In some examples, the actuator controller 730 generates and sends the first electrical current via a first electrical signal to the multilayer stack of piezoelectric material 540 and the multilayer stack of piezoelectric material 550 located in the actuator 515 and the actuator 520, respectively. In some examples, the first electrical current causes a first linear displacement in the multilayer stack of piezoelectrical material 540 and the multilayer stack of piezoelectric material 550.

At block 935, the example actuator controller 730 sends a second electrical current to a third multilayer stack of piezoelectric material and a fourth multilayer stack of piezoelectric material. In some examples, the third multilayer stack of piezoelectric material is substantially similar to the multilayer stack of piezoelectric material 545, and the fourth multilayer stack of piezoelectric material is substantially similar to the multilayer stack of piezoelectric material 555. In some examples, the actuator controller 730 generates and sends the second electrical current via a second electrical signal to the multilayer stack of piezoelectric material 545 and the multilayer stack of piezoelectric material 555 located in the actuator 515 and the actuator 520, respectively. In some examples, the second electrical current causes a second linear displacement in the multilayer stack of piezoelectrical material 545 and the multilayer stack of piezoelectric material 555. In some examples, the second linear displacement is opposite of the first linear displacement. For example, if the first linear displacement is an increase in length and a decrease in thickness of the multilayer stack of piezoelectrical material 540 and the multilayer stack of piezoelectric material 550, then the second linear displacement is a decrease in length and an increase in thickness of the multilayer stack of piezoelectrical material 545 and the multilayer stack of piezoelectric material 555. While blocks 930 and 935 are shown in sequence, they can be executed in parallel. After the example actuator controller 730 sends the second electrical current to a third multilayer stack of piezoelectric material and a fourth multilayer stack of piezoelectric material, program 900 ends.

At block 940, the example actuator controller 730 sends a third electrical current to a first multilayer stack of piezoelectric material and a second multilayer stack of piezoelectric material. In some examples, the actuator controller 730 generates and sends the third electrical current via a third electrical signal to the multilayer stack of piezoelectric material 540 and the multilayer stack of piezoelectric material 550. In some examples, the third electrical current causes a third linear displacement in the multilayer stack of piezoelectrical material 540 and the multilayer stack of piezoelectric material 550.

At block 945, the example actuator controller 730 sends a fourth electrical current to a third multilayer stack of piezoelectric material and a fourth multilayer stack of piezoelectric material. In some examples, the actuator controller 730 generates and sends the fourth electrical current via a fourth electrical signal to the multilayer stack of piezoelectric material 545 and the multilayer stack of piezoelectric material 555. In some examples, the fourth electrical current causes a fourth linear displacement in the multilayer stack of piezoelectrical material 545 and the multilayer stack of piezoelectric material 555. In some examples, the fourth linear displacement is opposite of the third linear displacement. For example, if the third linear displacement is a decrease in length and an increase in thickness of the multilayer stack of piezoelectrical material 540 and the multilayer stack of piezoelectric material 550, then the fourth linear displacement is an increase in length and a decrease in thickness of the multilayer stack of piezoelectrical material 545 and the multilayer stack of piezoelectric material 555. While blocks 940 and 945 are shown in sequence in the example of FIG. 9, in certain examples, they can be executed in parallel. After the example actuator controller 730 sends the fourth electrical current to the third multilayer stack of piezoelectric material and a fourth multilayer stack of piezoelectric material, program 900 ends.

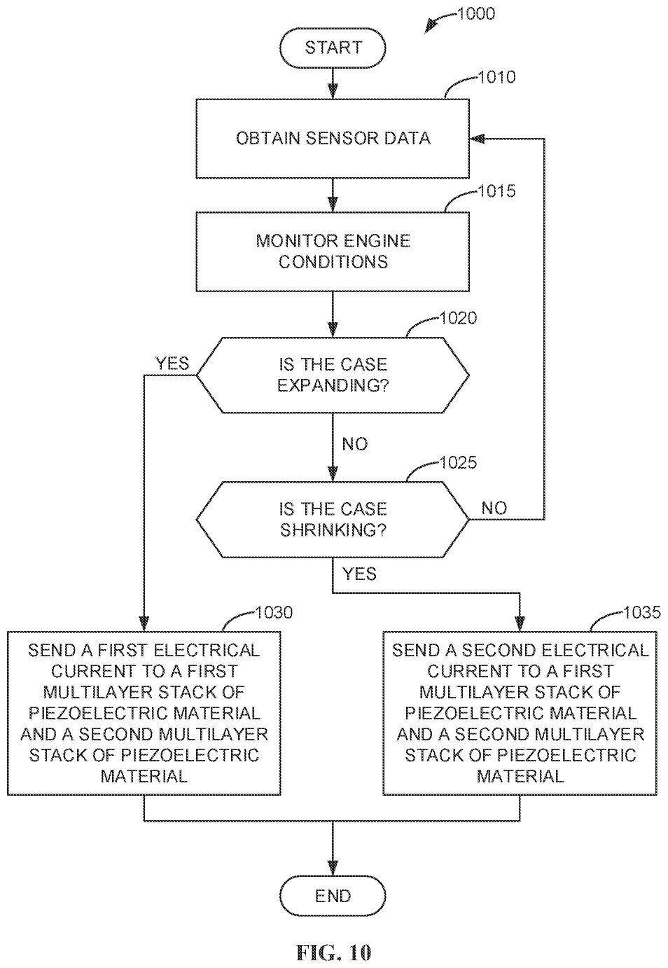

FIG. 10 is a flowchart representative of machine readable instructions that can be executed to implement the example controller of FIG. 7 in conjunction with the example ACC system 600, 670 of FIGS. 6A, 6B. The program 1000 of FIG. 10 begins execution at block 1010 at which the example the example sensor(s) processor 720 obtains sensor data from the example engine sensor(s) 710. In some examples, the sensor data includes the flight condition data obtained by the engine sensor(s) 710 from an engine (e.g., the gas turbine engine 100 of FIG. 1). In some examples, flight condition data of the sensor data includes values for a plurality of input variables relating to flight conditions (e.g., air density, throttle lever position, engine temperatures, engine pressures, etc.).

At block 1015, the example sensor(s) processor 720 monitors engine conditions based on the sensor data from the engine sensor(s) 710. For example, the sensor(s) processor 720 can calculate and monitor the fuel flow, stator vane position, air bleed valve position, etc., using the flight condition data included in the sensor data. At block 1020, the example sensor(s) processor 720 determines if the case is expanding. In some examples, the case is a case surrounding a high pressure turbine (e.g., the HP turbine 118 of FIG. 1), a low pressure turbine (e.g., the LP turbine 120 of FIG. 1) or a compressor (e.g., the HP compressor 114 and LP compressor 112 of FIG. 1). In some example, the sensor(s) processor 720 determines if the case is expanding based on the engine conditions determined from the obtained flight condition data. If the example sensor(s) processor 720 determines that the case is expanding, then the example program 1000 continues to block 1030 at which the example actuator controller 730 sends a first electrical current to a first multilayer stack of piezoelectric material and a second multilayer stack of piezoelectric material. If the example sensor(s) processor 720 determines that the case is not expanding, then the example program 1000 continues to block 1025 at which the example sensor(s) processor 720 determines if the case is shrinking.

At block 1025, the example sensor(s) processor 720 determines if the case is shrinking. In some example, the sensor(s) processor 720 determines if the case is shrinking based on the engine conditions determined from the obtained flight condition data. If the example sensor(s) processor 720 determines that the case is shrinking, then the example program 1000 continues to block 1035 at which the example actuator controller 730 sends a second electrical current to a first multilayer stack of piezoelectric material and a second multilayer stack of piezoelectric material. If the example sensor(s) processor 720 determines that the case is not shrinking, then the example program 1000 returns to block 1010 at which the example sensor(s) processor 720 obtains sensor data.

At block 1030, the example actuator controller 730 sends a first electrical current to a first multilayer stack of piezoelectric material and a second multilayer stack of piezoelectric material. In some examples, the first multilayer stack of piezoelectric material is substantially similar to multilayer stack of piezoelectric material 640, and the second multilayer stack of piezoelectric material is substantially similar to multilayer stack of piezoelectric material 650. In some examples, the actuator controller 730 generates and sends the first electrical current via a first electrical signal to the multilayer stack of piezoelectric material 640 and the multilayer stack of piezoelectric material 650 located in the actuator 615 and the actuator 620, respectively. In some examples, the first electrical current causes a linear displacement in the multilayer stack of piezoelectrical material 640 and the multilayer stack of piezoelectrical material 650 that moves the shroud 630 towards the blade 635 (similar to the example ACC system 670 of FIG. 6B). After the example actuator controller 730 sends the first electrical current, the program 1000 ends.

At block 1035, the example actuator controller 730 sends a second electrical current to a first multilayer stack of piezoelectric material and a second multilayer stack of piezoelectric material. In some examples, the actuator controller 730 generates and sends the second electrical current via a second electrical signal to the multilayer stack of piezoelectric material 640 and the multilayer stack of piezoelectric material 650 located in the actuator 615 and the actuator 620, respectively. In some examples, the second electrical current causes a linear displacement in the multilayer stack of piezoelectrical material 640 and the multilayer stack of piezoelectrical material 650 that moves the shroud 630 away from the blade 635 (similar to the example ACC systems 600 of FIG. 6A). While blocks 1030 and 1035 are shown in sequence, they can be executed in parallel. After the example actuator controller 730 sends the second electrical current, program 1000 ends.

FIG. 11 is a block diagram of an example processor platform 1100 structured to execute the instructions of FIGS. 8, 9, and 10 to implement the example controller 700 of FIG. 7. The processor platform 1100 can be, for example, a server, a personal computer, a workstation, a self-learning machine (e.g., a neural network), a mobile device (e.g., a tablet such as an iPad), or any other type of computing device.

The processor platform 1100 of the illustrated example includes a processor 1112. The processor 1112 of the illustrated example is hardware. For example, the processor 1112 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example sensor(s) processor 720 and the example actuator controller 730.

The processor 1112 of the illustrated example includes a local memory 1113 (e.g., a cache). The processor 1112 of the illustrated example is in communication with a main memory including a volatile memory 1114 and a non-volatile memory 1116 via a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1116 may be implemented by flash memory and/or any other desired type of memory device. Access to the main memory 1114, 1116 is controlled by a memory controller.

The processor platform 1100 of the illustrated example also includes an interface circuit 1120. The interface circuit 1120 may be implemented by any type of interface standard, such as an Ethernet interface, a universal serial bus (USB), a Bluetooth® interface, a near field communication (NFC) interface, and/or a PCI express interface.

In the illustrated example, one or more input devices 1122 are connected to the interface circuit 1120. The input device(s) 1122 permit(s) a user to enter data and/or commands into the processor 1112. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1124 are also connected to the interface circuit 1120 of the illustrated example. The output devices 1124 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1120 of the illustrated example, thus, typically includes a graphics driver card, a graphics driver chip and/or a graphics driver processor.

The interface circuit 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1126. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1100 of the illustrated example also includes one or more mass storage devices 1128 for storing software and/or data. Examples of such mass storage devices 1128 include floppy disk drives, hard drive disks, compact disk drives, and redundant array of independent disks (RAID) systems.

The machine executable instructions 1132 of FIGS. 8, 9, and 10 may be stored in the mass storage device 1128, in the volatile memory 1114, in the non-volatile memory 1116, and/or on a removable non-transitory computer readable storage medium such as a CD or DVD.

From the foregoing, it will be appreciated that example methods, apparatus and articles of manufacture have been disclosed that improve clearance control in a gas turbine engine. The disclosed examples propose improved ACC designs using a piezoelectric actuator to achieve tighter clearance at any operating conditions with fast mechanical ACC modulation. The disclosed examples use piezoelectric material to generate high mechanical power and provide fast response clearance control in two directions (inward and outward) with no time delay. The disclosed examples use multilayer stacks of the piezoelectric material to manage the range of displacement, which effects the range of the ACC system muscle capability. The disclosed examples propose simpler ACC design with weight reduction and increased space in the undercowl for other components of the gas turbine engine to be installed more freely. The disclosed examples improve engine performance and EGT control capability with additional SFC benefit due to saving airflow because no cooling airflow is needed for the mechanical ACC system.

Example methods, apparatus, systems, and articles of manufacture to provide fast response active clearance control system with piezoelectric actuator are disclosed herein. Further examples and combinations thereof include the following:

Example 1 includes an apparatus to control clearance for a turbine engine, the apparatus comprising a case surrounding at least part of the turbine engine, the at least part of the turbine engine including at least one of a shroud or a hanger to contain airflow in the at least part of the turbine engine, an actuator to control clearance between a blade and the at least one of the shroud or the hanger, the actuator including a multilayer stack of material, and wherein the actuator is outside of the case, and a rod coupled to the actuator and the at least one of the shroud or the hanger through an opening in the case, the rod to move the at least one of the shroud or the hanger based on the actuator.

Example 2 includes the apparatus of any preceding clause, wherein the at least part of the turbine engine includes a turbine or a compressor.

Example 3 includes the apparatus of any preceding clause, wherein the actuator controls clearance for a group of shrouds in the at least part of the turbine engine or for a partial group of shrouds in the at least part of the turbine engine.

Example 4 includes the apparatus of any preceding clause, the apparatus further including a sealing coupled to the rod, the sealing to prevent leakage through the opening in the case.

Example 5 includes the apparatus of any preceding clause, wherein the case is coupled to the at least one of the shroud or the hanger using guiding hooks.

Example 6 includes the apparatus of any preceding clause, wherein the multilayer stack of material includes at least one of piezoelectric material or shape memory alloy.

Example 7 includes the apparatus of any preceding clause, the apparatus further including a controller operatively coupled to the actuator, the controller to supply an electrical current to the multilayer stack of material in the actuator.

Example 8 includes the apparatus of any preceding clause, wherein the multilayer stack of material is displaced by the electrical current.

Example 8 includes the apparatus of any preceding clause, wherein the actuator controls clearance between the blade and the at least one of the shroud or the hanger using the displacement of the multilayer stack of material.

Example 10 includes an apparatus to control clearance for a turbine engine, the apparatus comprising a case surrounding at least part of the turbine engine, the at least part of the turbine engine including at least one of a shroud or a hanger to contain airflow in the turbine engine, a first actuator to control clearance between a blade and the at least one of the shroud or the hanger, the first actuator including a first multilayer stack of material, and wherein the first actuator is coupled to the at least one of the shroud or a first hook of the hanger, and a second actuator to control clearance between the blade and the at least one of the shroud or the hanger, the second actuator including a second multilayer stack of material, and wherein the second actuator is coupled to the at least one of the shroud or a second hook of the hanger.

Example 11 includes the apparatus of any preceding clause, wherein the at least part of the turbine engine includes a turbine or a compressor.

Example 12 includes the apparatus of any preceding clause, wherein the first actuator and the second actuator control clearance for a group of shrouds in the at least part of the turbine engine or for a partial group of shrouds in the at least part of the turbine engine.

Example 13 includes the apparatus of any preceding clause, wherein the first multilayer stack of material and the second multilayer stack of material includes at least one of piezoelectric material or shape memory alloy.

Example 14 includes the apparatus of any preceding clause, the first actuator further including a third multilayer stack of material, and the second actuator further including a fourth multilayer stack of material.

Example 15 includes the apparatus of any preceding clause, wherein the first multilayer stack of material is coupled to a top surface of the at least one of the shroud or the first hook of the hanger and a bottom surface of the case, and wherein the third multilayer stack of material is coupled to a bottom surface of the at least one of the shroud or the first hook of the hanger.

Example 16 includes the apparatus of any preceding clause, wherein the third multilayer stack of material is coupled to a top surface of the at least one of the shroud or the second hook of the hanger and a bottom surface of the case, and wherein the fourth multilayer stack of material is coupled to a bottom surface of the at least one of the shroud or the second hook of the hanger.

Example 17 includes the apparatus of any preceding clause, the first actuator further including a first spring, and the second actuator further including a second spring.

Example 18 includes the apparatus of any preceding clause, wherein the first multilayer stack of material is coupled to a top surface of the at least one of the shroud or the first hook of the hanger and a bottom surface of the case, and wherein the first spring is coupled to a bottom surface of the at least one of the shroud or the first hook of the hanger.

Example 19 includes the apparatus of any preceding clause, wherein the second multilayer stack of material is coupled to a top surface of the at least one of the shroud or the second hook of the hanger and a bottom surface of the case, and wherein the second spring is coupled to a bottom surface of the at least one of the shroud or the second hook of the hanger.

Example 20 includes the apparatus of any preceding clause, the apparatus further including a controller operatively coupled to the first actuator and the second actuator, the controller to supply a first electrical current to the first multilayer stack of material and the second multilayer stack of material.

Example 21 includes the apparatus of any preceding clause, wherein the controller is to supply a second electrical current to the third multilayer stack of material and the fourth multilayer stack of material.

Example 22 includes the apparatus of any preceding clause, wherein the first multilayer stack of material and the third multilayer stack of material are displaced by the first electrical current, and the third multilayer stack of material and the fourth multilayer stack of material are displaced by the second electrical current.

Example 23 includes the apparatus of any preceding clause, wherein the first actuator and second actuator control clearance between the at least one of the shroud or the hanger and the blade using the displacement of the first multilayer stack of material, the second multilayer stack of material, the third multilayer stack of material, and the fourth multilayer stack of material.

Example 24 includes the apparatus of any preceding clause, the apparatus further including a controller operatively coupled to the first actuator and the second actuator, the controller to supply an electrical current to the first multilayer stack of material and the second multilayer stack of material.

Example 25 includes the apparatus of any preceding clause, wherein the first multilayer stack of material and the second multilayer stack of material are displaced by the electrical current.

Example 26 includes the apparatus of any preceding clause, wherein the first actuator and second actuator control clearance between the blade and the at least one of the shroud or the hanger using the displacement of the first multilayer stack of material and the second multilayer stack of material, and wherein the first spring supports displacement of the first multilayer stack of material and the second spring supports the displacement the second multilayer stack of material.

Example 27 includes a non-transitory computer readable medium comprising instructions that, when executed, cause at least one processor to at least monitor condition parameters from sensor devices in a turbine engine, determine when turbine engine conditions indicate if a case is expanding or shrinking, wherein the turbine engine conditions are based on the condition parameters, the case surrounding at least part of the turbine engine, in response to determining that the turbine engine conditions indicate the case is expanding, transmit a first electrical current to a multilayer stack of material, and in response to determining that the turbine engine conditions indicate the case is shrinking, transmit a second electrical current to the multilayer stack of material.

Example 28 includes the non-transitory computer readable medium of any preceding clause, wherein the at least part of the turbine engine includes a turbine or a compressor.

Example 29 includes the non-transitory computer readable medium of any preceding clause, wherein the condition parameters include temperature measurements, pressure measurements, or air density measurements.

Example 30 includes the non-transitory computer readable medium of any preceding clause, wherein the multilayer stack of material includes at least one of piezoelectric material or shape memory alloy.

Example 31 includes the non-transitory computer readable medium of any preceding clause, wherein the multilayer stack of material is a first multilayer stack of material, and wherein the instructions that, when executed, cause the at least one processor to in response to determining that the turbine engine conditions indicate the case is expanding transmit the first electrical current to a second multilayer stack of material, and transmit the second electrical current to a third multilayer stack of material and a fourth multilayer stack of material, and in response to determining that the turbine engine conditions indicate the case is shrinking transmit a third electrical current to the first multilayer stack of material and the second multilayer stack of material, and transmit a fourth electrical current to the third multilayer stack of material and the fourth multilayer stack of material.

Example 32 includes the non-transitory computer readable medium of any preceding clause, wherein the multilayer stack of material is a first multilayer stack of material, and wherein the instructions that, when executed, cause the at least one processor is to in response to determining that the turbine engine conditions indicate the case is expanding transmit the first electrical current to a second multilayer stack of material, and in response to determining that the turbine engine conditions indicate the case is shrinking transmit the second electrical current to the first multilayer stack of material and the second multilayer stack of material.

Although certain example methods, apparatus and articles of manufacture have been disclosed herein, the scope of coverage of this patent is not limited thereto. For example, the disclosed example methods, apparatus and articles of manufacture are implemented in conjunction with a gas turbine engine, however, the disclosed examples can be implemented in conjunction with a compressor. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

1. An apparatus to control clearance for a turbine engine, the apparatus comprising:
a case surrounding at least part of the turbine engine, the at least part of the turbine engine including at least one of a shroud or a hanger to contain airflow in the at least part of the turbine engine;
an actuator to control clearance between a blade and the at least one of the shroud or the hanger, the actuator including a multilayer stack of material, and wherein the actuator is outside of the case; and
a rod coupled to the actuator and the at least one of the shroud or the hanger through an opening in the case, the rod to move the at least one of the shroud or the hanger based on the multilayer stack of material.

2. The apparatus of claim 1, wherein the at least part of the turbine engine includes a turbine or a compressor.

3. The apparatus of claim 1, wherein the actuator controls clearance for a group of shrouds in the at least part of the turbine engine or for a partial group of shrouds in the at least part of the turbine engine.

4. The apparatus of claim 1, wherein the multilayer stack of material includes at least one of piezoelectric material or shape memory alloy.

5. The apparatus of claim 4, the apparatus further including a controller operatively coupled to the actuator, the controller to supply an electrical current to the multilayer stack of material in the actuator, the multilayer stack of material displaced by the electrical current.

6. The apparatus of claim 5, wherein the actuator controls clearance between the blade and the at least one of the shroud or the hanger using the displacement of the multilayer stack of material.

7. An apparatus to control clearance for a turbine engine, the apparatus comprising:
a case surrounding at least part of the turbine engine, the at least part of the turbine engine including at least one of a shroud or a hanger to contain airflow in the turbine engine;
a first actuator to control clearance between a blade and the at least one of the shroud or the hanger, the first actuator including a first multilayer stack of material, and wherein the first actuator is coupled to the at least one of the shroud or a first hook of the hanger; and
a second actuator to control clearance between the blade and the at least one of the shroud or the hanger, the second actuator including a second multilayer stack of material, and wherein the second actuator is coupled to the at least one of the shroud or a second hook of the hanger.

8. The apparatus of claim 7, wherein the at least part of the turbine engine includes a turbine or a compressor.

9. The apparatus of claim 7, wherein the first multilayer stack of material and the second multilayer stack of material includes at least one of piezoelectric material or shape memory alloy.

10. The apparatus of claim 9, the first actuator further including a third multilayer stack of material, and the second actuator further including a fourth multilayer stack of material.

11. The apparatus of claim 7, the first actuator further including a first spring, and the second actuator further including a second spring.

12. The apparatus of claim 10, the apparatus further including a controller operatively coupled to the first actuator and the second actuator, the controller to supply a first electrical current to the first multilayer stack of material and the second multilayer stack of material, the controller to supply a second electrical current to the third multilayer stack of material and the fourth multilayer stack of material.

13. The apparatus of claim 12, wherein the first multilayer stack of material and the third multilayer stack of material are displaced by the first electrical current, and the third multilayer stack of material and the fourth multilayer stack of material are displaced by the second electrical current.

14. The apparatus of claim 13, wherein the first actuator and second actuator control clearance between the at least one of the shroud or the hanger and the blade using the displacement of the first multilayer stack of material, the second multilayer stack of material, the third multilayer stack of material, and the fourth multilayer stack of material.

15. The apparatus of claim 11, the apparatus further including a controller operatively coupled to the first actuator and the second actuator, the controller to supply an electrical current to the first multilayer stack of material and the second multilayer stack of material, the first multilayer stack of material and the second multilayer stack of material displaced by the electrical current.

16. The apparatus of claim 15, wherein the first actuator and second actuator control clearance between the blade and the at least one of the shroud or the hanger using the displacement of the first multilayer stack of material and the second multilayer stack of material, and wherein the first spring supports displacement of the first multilayer stack of material and the second spring supports the displacement the second multilayer stack of material

17.-20. (canceled)
